(19) United States
(12) Patent Application Publication
(10) Pub. No.: US 2017/0139267 A1
(43) Pub. Date: May 18, 2017

(54) COLOR FILTERS AND THE MANUFACTURING METHOD THEREOF, AND LIQUID CRYSTAL DEVICES (LCDS)

(71) Applicant: Wuhan China Star Optoelectronics Technology Co., Ltd., Wuhan, Hubei (CN)

(72) Inventors: Haiyan SUN, Shenzhen, Guangdong (CN); Dan WANG, Shenzhen, Guangdong (CN); Chong LONG, Shenzhen, Guangdong (CN)

(73) Assignee: Wuhan China Star Optoelectronics Technology Co., Ltd., Wuhan, Hubei (CN)

(21) Appl. No.: 14/778,936

(22) PCT Filed: Aug. 26, 2015
(86) PCT No.: PCT/CN2015/088158

§ 371 Date: Sep. 21, 2015

(30) Foreign Application Priority Data
May 7, 2015 (CN) 201510230606.9

(51) Int. Cl. G02F 1/1335; G02F 1/1337; G02F 1/1368

(52) U.S. Cl. CPC G02F 1/133514; G02F 1/133512; G02F 1/1368; G02F 1/1337; G02F 1/133516

(57) ABSTRACT

The present disclosure relates to a color filter including components having black matrixes, a color layer, a protection layer, and a gap layer. At least one of the components is provided with the blue light absorbing agents. A weight of the blue light absorbing agents is in a range of 1% and 10% of a total weight of the component containing the blue light absorbing agents. In view of the above, the components of the color filters are configured with blue light absorbing agents for absorbing a portion or all of the blue lights harmful to human eyes, which reduces the risks of damaging the eyesight.

### BACKGROUND OF THE INVENTION

1. Field of the Invention

The present disclosure relates to liquid crystal display technology, and more particularly to a (LCD) with eye protection.

2. Discussion of the Related Art

According to medical researches, the wavelength of visible lights of human eyes is above 390 nm and is below 760 nm. With respect to the visible lights emitted by the display panels, blue lights have the shortest wavelength and is the most powerful one. The blue lights may include blue, indigo blue, and purple lights, which may passing through cornea and crystal lens and then enter macula. This results in that the cells of the macula are oxidized, and the light sensing cells of the retina may be harmed, and so does the eyesight.

Filtering blue lights on the liquid crystal panels to protect the eye is a critical issue. Currently, popular solutions includes adopting blue lights protection film, wearing blue-lights-filtering glasses, or adopting corresponding blue lights components, however, these solutions may cause other issues. For instance, the brightness of the display panel and the sensibility of the display panels may be reduced, which cause the inconvenience and the color shift.

### SUMMARY

In order to overcome the above problems, the color filters and the manufacturing method thereof, and the LCDs adopting the color filters are provided.

In one aspect, a color filter includes: components comprising black matrixes, a color layer, and a protection layer, at least one of the components being provided with blue light absorbing agents, and a weight of the blue light absorbing agents being in a range of 1% and 10% of a total weight of the component containing the blue light absorbing agents.

Wherein the color filter further comprises a gap layer arranged above the protection layer, and the gap layer is provided with the blue light absorbing agents.

Wherein the color filter further comprises an alignment layer being arranged on the protection layer, and the alignment layer is provided with the blue light absorbing agents.

Wherein the color filter further comprises an alignment layer being arranged on the protection layer, the alignment layer is provided with the blue light absorbing agents, and the weight of the blue light absorbing agents is in a range of 1% and 10% of a total weight of the component containing the blue light absorbing agents

Wherein the blue light absorbing agents is organic polymer or inorganic materials capable of absorbing the lights having the wavelength in a range of 380 nm and 500 nm.

In another aspect, a liquid crystal device (LCD) includes: a color filter comprising components comprising black matrixes, a color layer, and a protection layer, at least one of the components being provided with blue light absorbing agents, and the a weight of the blue light absorbing agents being in a range of 1% and 10% of a total weight of the component containing the blue light absorbing agents.

Wherein the color filter further comprises a gap layer arranged above the protection layer, and the gap layer is provided with the blue light absorbing agents.

Wherein a first alignment film is provided on the protection layer, and a thin film transistor (TFT) assembly is arranged below the color filter, the TFT assembly is covered by a second alignment film, the first alignment film and the second alignment film are provided with the blue light absorbing agents.

Wherein the blue light absorbing agents is organic polymer or inorganic materials capable of absorbing the lights having the wavelength in a range of 380 nm and 500 nm.

In another aspect, a manufacturing method of color filters includes: obtaining manufacturing material of components comprising black matrixes, a color layer, and a protection layer; and adding blue light absorbing agents to one or more than one components, and a weight of the blue light absorbing agents being in a range of 1% and 10% of a total weight of the component containing the blue light absorbing agents.

Wherein the blue light absorbing agents is organic polymer or inorganic materials capable of absorbing the lights having the wavelength in a range of 380 nm and 500 nm.

In view of the above, the components of the color filters are configured with blue light absorbing agents for absorbing a portion or all of the blue lights harmful to human eyes, which reduces the risks of damaging the eyesight. On the other hand, the structure of the color filters remains the same, and the blue light absorbing agents are introduced without affecting the display performance. This eliminates the issues caused by the blue lights, such as inconvenience and the color shift, and thus may be widely adopted.

### BRIEF DESCRIPTION OF THE DRAWINGS

FIG. 1 is a schematic view of the color filter in accordance with a first embodiment.

FIG. 2 is a schematic view of the backlight module in accordance with a second embodiment.

### DETAILED DESCRIPTION OF THE EMBODIMENTS

Embodiments of the invention will now be described more fully hereinafter with reference to the accompanying drawings, in which embodiments of the invention are shown.

In the embodiment, the structure of the color filter remains unchanged, and the blue light absorbing agents, i.e., the absorbing agents of visible light wavelength, are introduced during the manufacturing of the photoresistor. A portion or all of the blue lights having the wavelength in a range of 380 nm and 430 nm are absorbed. With such configuration, the display panel may be implemented without affecting the display performance so as to protect the eyesight.

Embodiments of the invention will now be described more fully hereinafter with reference to the accompanying drawings, in which embodiments of the invention are shown.

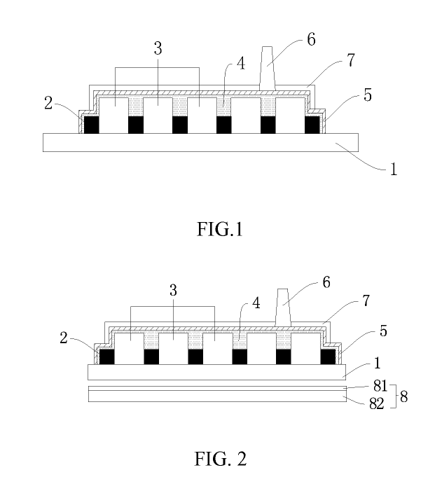

In the embodiment, the color filter, as shown in FIG. 1, includes components arranged on the glass substrate 1 in sequence. The components include black matrixes 2, a color layer 3, a protection layer 4, an electrode layer 5, a first alignment layer 7, and a gap layer 6. The protection layer 4, the electrode layer 5, and the first alignment layer 7 are formed on the color layer 3 in sequence. The gap layer 6 is formed on the electrode layer 5. At least one of the black matrixes 2, the color layer 3, the protection layer 4, the first alignment layer 7, and the gap layer 6 may contain the blue light absorbing agents. In addition, the weight of the blue light absorbing agents is in a range of 1% and 10% of the total weight of the component containing the blue light absorbing agents. It can be understood that the structure of the color filter is not limited to the above.

In the embodiment, the LCD includes the above color filter. As shown in FIG. 2, the LCD include the above color filter and the thin film transistor (TFT) assembly 8 arranged below the color filter. The TFT assembly 8 includes a TFT component 82 and a second alignment film 81 covering the TFT component. The second alignment film 81 is capable of absorbing the blue lights. The weight of the blue light absorbing agents is in a range of 1% and 10% of the total weight of the component containing the blue light absorbing agents.

In the embodiment, the blue light absorbing agents may be the organic polymer or inorganic materials capable of absorbing the lights having the wavelength in a range of 380 nm and 500 nm. For instance, the blue light absorbing agents may be OMNISTAB™ 47, and the maximum absorbing wavelength is 475 nm. The blue light absorbing agents may be resolved in most of the solvents having good heat stability.

The manufacturing method of the color filter will be described hereinafter. The manufacturing process may be conducted within the LCD factories. The manufacturing method includes the steps described below.

A) A cleaning step, which relates to initial clean (ICL), for cleaning the glass substrate.

B) A Cr sputter (CRL) step, for coating a Cr-layer on the glass substrate to form a mask.

C) A black matrix (BM) step for forming the black matrix on the Cr-layer, i.e., the mask. The material of the black matrix may be black photosensitive resin.

D) A color filter (respectively referred to as R, G, B) step for obtaining color blocks of three colors, which are respectively red, green, and blue. The manufacturing material of the color layer may be adjusted in accordance with the different manufacturing method. In an example, the manufacturing material may be negative type photosensitive resin including rec, green, and blue colors.

E) A over-coat (OC) step for manufacturing the OC layer on the above pattern. The material of the OC layer may be PPMA or EPOXY.

F) An ITO sputter (ITO) layer step for forming conductive film on the protection layer. The ITO layer may be made by indium tin oxide.

G) a photo spacer (PS) step for forming a plurality of supporting or blocks on the alignment film. The PS may be made by negative photosensitive material, which is substantial the same with or similar to the material of the color filter.

H) An alignment film manufacturing step.

In the above steps between B and G, any one of the components may be provided with the blue light absorbing agents. Taking the BM step as one example, as shown in FIG. 2, the condition includes the temperature is in a range of 10 to 25° C., the moisture is below 50%, the clean room is of class 10 or class 100. The manufactured BM material is thawed out to the room temperature. Afterward, the blue light absorbing agents, such as OMNISTAB™ 47, is added to the total material with the weight in a range of 1% and 10% of the total weight of the total material, and the blue light absorbing agents and the total material are mixed uniformly. The resulting product is then filtered by 1 μm filtration membrane and then is defoaming. In the end, the BM manufacturing material having the blue light absorbing agents is re-filled to the material bucket for the manufacturing apparatuses.

It can be understood that the BM manufacturing material may be replaced by the manufacturing material in any one of the steps between C and G. The process of adding the blue light absorbing agents is similar. In another example, two or more than two steps may be selected such that the blue light absorbing agents may be added to the manufacturing material of two or more than two components.

With respect to the (H) step, the blue light absorbing agents may be added to the material bucket of the alignment film so as to obtain the alignment film. The detailed operations may be referred to the BM manufacturing process wherein the blue light absorbing agents are added. As the first alignment film and the second alignment film are configured with the blue light absorbing agents, the capability of absorbing the blue lights may be greatly enhanced.

In the second embodiment, the blue light absorbing agents are added in the process of material manufacture of each of the components, which is conducted during the photoresistor manufacturing plants.

The manufacturing method of the BM manufacturing material is an example and the method includes the steps described below.

In step one, the reaction material, such as mixture of pigment and the distribution liquid, polymers, and photosensitizer. The reaction material are mixed and stirred for a time period so as to manufacture the photoresistor materials for manufacturing the BM.

In step two, the blue light absorbing agents, OMNISTAB™ 47, is adding during the above process. The weight of the blue light absorbing agents is in a range of 1% and 10% of the total weight of the component containing the blue light absorbing agents.

In step three, the BM manufacturing material, after being added with the blue light absorbing agents, is filtered and packed so as to be shipped or transmitted to the LCD manufacturing plants. The mixture is then added to the material bucket for further manufacturing process.

It can be understood that the manufacturing process of the BM manufacturing material stated in steps 1 through 3 may also be applied to the manufacturing material of R, G, B, OC, and PS. Thus, the blue light absorbing agents may also be added to the manufacturing material of the R, G, B, OC, and PS. The weight of the blue light absorbing agents is in a range of 1% and 10% of the total weight of the component containing the blue light absorbing agents.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A color filter, comprising:
components comprising black matrixes, a color layer, and a protection layer, at least one of the components being provided with blue light absorbing agents, and a weight of the blue light absorbing agents being in a range of 1% and 10% of a total weight of the component containing the blue light absorbing agents.

2. The color filter as claimed in claim 1, wherein the color filter further comprises a gap layer arranged above the protection layer, and the gap layer is provided with the blue light absorbing agents.

3. The color filter as claimed in claim 1, wherein the color filter further comprises an alignment layer being arranged on the protection layer, and the alignment layer is provided with the blue light absorbing agents.

4. The color filter as claimed in claim 2, wherein the color filter further comprises an alignment layer being arranged on the protection layer, the alignment layer is provided with the blue light absorbing agents, and the weight of the blue light absorbing agents is in a range of 1% and 10% of a total weight of the component containing the blue light absorbing agents

5. The color filter as claimed in claim 3, wherein the blue light absorbing agents is organic polymer or inorganic materials capable of absorbing the lights having the wavelength in a range of 380 nm and 500 nm.

6. The color filter as claimed in claim 4, wherein the blue light absorbing agents is organic polymer or inorganic materials capable of absorbing the lights having the wavelength in a range of 380 nm and 500 nm.

7. A liquid crystal device (LCD), comprising:
a color filter comprising components comprising black matrixes, a color layer, and a protection layer, at least one of the components being provided with blue light absorbing agents, and the a weight of the blue light absorbing agents being in a range of 1% and 10% of a total weight of the component containing the blue light absorbing agents.

8. The LCD as claimed in claim 7, wherein the color filter further comprises a gap layer arranged above the protection layer, and the gap layer is provided with the blue light absorbing agents.

9. The LCD as claimed in claim 7, wherein a first alignment film is provided on the protection layer, and a thin film transistor (TFT) assembly is arranged below the color filter, the TFT assembly is covered by a second alignment film, the first alignment film and the second alignment film are provided with the blue light absorbing agents.

10. The LCD as claimed in claim 8, wherein a first alignment film is provided on the protection layer, and a TFT assembly is arranged below the color filter, the TFT assembly is covered by a second alignment film, the first alignment film and the second alignment film are provided with the blue light absorbing agents.

11. The LCD as claimed in claim 9, wherein the blue light absorbing agents is organic polymer or inorganic materials capable of absorbing the lights having the wavelength in a range of 380 nm and 500 nm.

12. A manufacturing method of color filters, comprising:
obtaining manufacturing material of components comprising black matrixes, a color layer, and a protection layer; and
adding blue light absorbing agents to one or more than one components, and a weight of the blue light absorbing agents being in a range of 1% and 10% of a total weight of the component containing the blue light absorbing agents.

13. The manufacturing method of the color filter as claimed in claim 12, wherein the blue light absorbing agents is organic polymer or inorganic materials capable of absorbing the lights having the wavelength in a range of 380 nm and 500 nm.
